(19) United States
(12) Patent Application Publication
(10) Pub. No.: US 2011/0033692 A1
(43) Pub. Date: Feb. 10, 2011

(54) COMPOSITE MATERIAL COMPOSED OF A METAL MATRIX IN WHICH CNT FILAMENTS ARE DISTRIBUTED, AND METHOD FOR THE PRODUCTION OF SUCH A COMPOSITE MATERIAL

(75) Inventors: Frank Heinrichsdorff, Mahlow (DE); Jens Dahl Jensen, Berlin (DE); Manuela Schneider, Berlin (DE); Raymond Ullrich, Schönwalde (DE); Gabriele Winkler, Berlin (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/736,475

(22) PCT Filed: Apr. 1, 2009
(86) PCT No.: PCT/EP2009/053843

§ 371 Date: Oct. 12, 2010

(30) Foreign Application Priority Data
Apr. 10, 2008 (DE) 10 2008 018 695.3

(51) Int. Cl. B32B 5/26; D03D 15/00; B32B 5/02; C25D 5/54; B82Y 30/00

(52) U.S. Cl. 428/222; 442/179; 428/367; 205/160; 977/742

(57) ABSTRACT

A composite material is composed of a metal matrix in which CNT filaments are distributed. The CNT filaments are intertwined, interwoven, or tied together, and the matrix is cold-worked. The matrix material is thereby filled with a higher percentage of CNT filaments than when dispersed CNT are electrodeposited. In a method for producing such a composite material, suitable semifinished products such as knitted fabrics, woven fabrics, nets, fleeces, or papers made of CNT filaments are coated (preferably electroplated) with the metal matrix.

### CROSS REFERENCE TO RELATED APPLICATIONS

This application is based on and hereby claims priority to International Application No. PCT/EP2009/053843 filed on Apr. 1, 2009 and German Application No. 10 2008 018 695.3 filed on Apr. 10, 2008, the contents of which are hereby incorporated by reference.

### BACKGROUND

The invention relates to a material composite composed of a metallic matrix in which CNT filaments are distributed. Furthermore, the invention relates to a process for the production of a material composite composed of a metallic matrix in which CNT filaments are distributed.

A material composite of the type mentioned in the introduction can be produced, for example, as per US 2007/0036978 A1. In this respect, CNTs are dispersed in an electrolyte and a component to be coated is coated by electrodeposition in this electrolyte. A layer which yields the material composite mentioned in the introduction is thereby deposited. The dispersed CNTs are specifically also incorporated in this layer, and are present in the material composite in a stoichiometric distribution with any desired orientation.

DE 600 25 131 T2 describes a fiber-reinforced composite material with a metal matrix. The filaments used may be carbon fibers, for example, which themselves are coated with a metal. These are mixed with the matrix material and processed as part of a so-called rapid prototyping process.

Limits which arise from the production process are imposed on the rate of incorporation of CNT filaments in the matrix. Specifically, dispersion of the CNTs in the electrolyte has to be stabilized using wetting agents, where the concentration of dispersed CNT is dependent on the efficiency of these wetting agents, but is limited. This can also be seen as the limiting factor when the CNTs are to be incorporated in the matrix material during the electrodeposition of the layer. This is so because it causes a steady state, which determines the limited rate of incorporation of CNT in the deposited matrix material.

In order to achieve a higher rate of incorporation of fibers, DE 102 15 101 A1 describes that it is also possible to cast mat-like semifinished products of the fibers into the component in the case of cast parts made of light metal alloys. This produces a composite body made of a light metal material as the matrix.

### SUMMARY

It is one possible object to specify a process for the production of a material composite with CNT filaments present therein, by which it is possible to increase the rate of incorporation of CNT filaments compared to the related art.

The inventors propose that a semifinished CNT product composed of a knitted fabric, a woven fabric, a mesh, a nonwoven or a paper is coated with the material of the metallic matrix. This allows the metallic matrix to be filled with CNT filaments virtually as desired. The reasons for this are as follows: compared to the process for coating by electrodeposition according to the related art, a base body on which the material composite is produced is not required. The support for the material composite is instead the semifinished product containing the CNT filaments itself. This can be obtained from suitable manufacturers in prefabricated form, where the fabrication governs the degree to which the material composite to be produced is filled with CNT. The degree to which the finished composite material is filled with CNT filaments also differs depending on how tightly the CNT filaments are intertwined or interwoven or interlinked. In any case, the material can be filled with a significantly higher percentage of CNT filaments by using the semifinished products mentioned than by electrodeposition of dispersed CNT.

It is advantageous if the material of the metallic matrix is applied to the semifinished CNT product electrochemically, preferably by electrodeposition, i.e. with the application of a deposition potential. This advantageously involves a process in which greater layer thicknesses can also be achieved with minimal outlay. The ratio of matrix material to the material of the CNT filaments can therefore be set on a relatively large scale. For electrodeposition, it is advantageous in this respect that CNT filaments are in principle electrically conductive. An electrical potential can therefore be applied to the semifinished product, which, by way of example, is dipped into an electrochemical coating bath and pulled out again (continuous coating process).

However, it is possible to improve the coating result and accelerate the coating if the electrochemical coating is preceded by pretreatment of the semifinished CNT product in order to improve the electrical conductivity and/or the adhesion properties for the material of the metallic matrix. A pretreatment of this type can be effected, for example, by coating by PVD coating technologies. In this case, a thin metallic layer which improves the electrical properties of the CNT filaments is produced on the CNTs. In particular, metallic bridges can be produced at the points of contact of the CNTs in the semifinished product. Electrochemical coating can therefore take place under relatively high deposition currents, and higher rates of deposition are thereby achieved.

Furthermore, it is advantageously also possible for the coating to be followed by heat treatment of the material composite. This has the advantage that it is possible to reduce stresses which may arise in the material composite as a result of the different mechanical properties of CNTs and metallic matrix materials. In addition, the matrix material is conditioned, in particular if heating is carried out to above the recrystallization temperature, in order to subsequently carry out forming, which proceeds on the basis of the cold-forming principle. By way of example, this may involve stretching of the material composite, and this promotes the above-mentioned preferred orientation of the CNT filaments.

It is also advantageous to separate the material composite into a plurality of sub-sections after the coating. By way of example, it is possible to coat the entire width of the nonwoven-like semifinished products, this producing a material composite which, in principle, is unsuitable as an electrical conductor, for example. However, a plurality of strips can be cut from the run produced, and it is then also possible to strand these with one another, for example.

One particular refinement of the process is therefore also obtained if the material composite is folded and/or layered and/or twisted after the coating. By way of example, this makes it possible to produce the above-mentioned stranded electrical conductors. For a continuous production process, it is lastly also advantageous if the semifinished CNT product has a strand-like form and the process steps are carried out continuously on a part of the semifinished CNT product and, respectively, of the resulting strand-like material composite.

The strand-like semifinished product therefore passes through the stages of the production process in succession, in which case the respective production step does not have to be stopped and started up or only rarely has to be stopped and started up.

It is a further object to specify a material composite with a metallic matrix and CNT filaments distributed therein, which makes relatively high rates of incorporation of CNT possible.

The inventors propose a material composite in which the CNT filaments are present in the matrix in an intertwined, interwoven or interlinked form, the matrix being present in a cold work-hardened state. This has the advantage that the material properties of the matrix can be adapted to the high-strength material properties of the CNTs embedded therein. This permits a more homogeneous behavior of the material composite in terms of its mechanical properties. Cold work-hardening is made possible by the fact that the CNT filaments are embedded electrochemically and not by casting or rapid prototyping. Specifically, this makes it possible to produce a microstructure which is ductile compared to cast microstructures. By way of example, the cold work-hardening can be effected by stretching the material composite, as a result of which it is advantageously possible to obtain a preferred orientation of the CNT filaments in the matrix material at the same time. Therefore, it is particularly advantageously also possible for the material composite to have a strand-like form. This strand can be work-hardened by stretching to produce, in particular, a material which is suitable for the above-mentioned application of an electrical conductor.

A self-supporting structure of CNT filaments is produced in the matrix, as a result of which the rates of incorporation of CNT in the metallic matrix can advantageously be increased greatly. The rate of incorporation is no longer determined by the establishment of a steady state (diffusion process in the electrolyte), but instead by the manner in which a semifinished CNT product used is made with CNT filaments, which are present in an intertwined or interwoven or interlinked form.

The semifinished products mentioned may be obtained, for example, from FutureCarbon. By way of example, on Feb. 13, 2008 this company offered 2D and 3D networks composed of CNT on their website (www.future-carbon.de), and these networks can be processed as a semifinished product in the production process (more details in this respect hereinbelow). It is also known, for example from Xiaobo Zhang et al. “Spinning and Processing Continuous Yarns from 4-Inch Wafer Scale Super-Aligned Carbon Nanotube Arrays”, Adv. Mater. 2006, 18, 1505-1510, to produce CNT filaments by pulling yarns from a “forest” of CNTs away from a silicon substrate. This involves a self-organizing process which leads to CNT filaments having a significantly greater length than the CNTs situated on the silicon substrate. These are then present in the form of a wool-like semifinished product, in which the CNT filaments are parallelized to a high degree. A semifinished product of this type can also serve for further processing in the material composite.

One particular refinement is obtained if the CNT filaments which are respectively intertwined or interwoven or interlinked are arranged in a plurality of adjacent layers in the matrix. In this context, it is possible, for example if relatively large cross-sectional areas of a material composite are required, to work with semifinished CNT products which alone would not fill the cross-sectional area required. By way of example, these might be strips of a CNT nonwoven. These are then layered in the production process, in which case parts of the metallic matrix through which CNT filaments do not pass form between the individual layers. The overall result is a material composite with a sandwich-like structure.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a perspective view of an exemplary embodiment of the material composite according to the proposal with a sectional plane through the cross section being shown;

FIG. 2 shows an exemplary embodiment of the process for the production of the material composite; and

FIGS. 3 and 4 show variants of further processing of the material composite according to further exemplary embodiments of the process.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

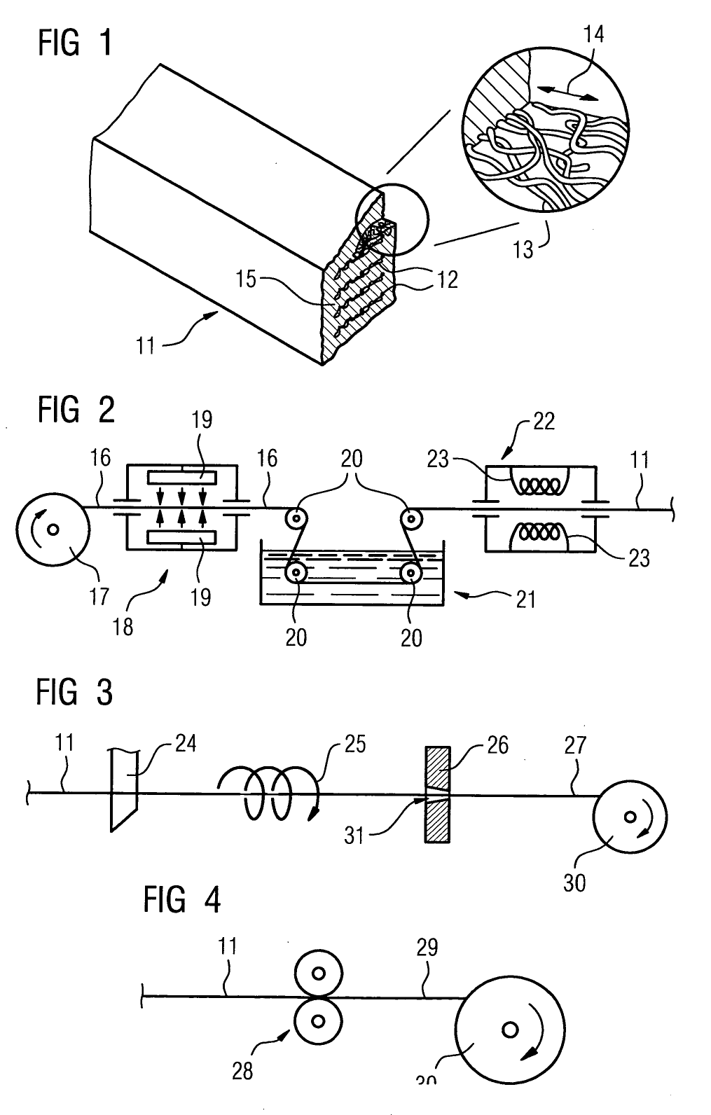

FIG. 1 shows a material composite 11 in the form of a sandwich composed of a plurality of layers 12 of a semifinished CNT product. As can be seen from the detailed enlargement according to FIG. 1, these layers 12 have intertwined CNT filaments 13. It can also be seen from the detailed enlargement that the layers 12 of CNT filaments 13 have a preferred orientation 14, and are oriented to the longitudinal extent of the strand-like material composite 11. By way of example, the semifinished CNT product may be formed of strips of a CNT nonwoven (not shown in more detail). The individual layers are completely surrounded by the material of the matrix 15. This can be achieved, for example, by electrochemical coating of the layers 12, which also ensures that the edges of the layers 12 are completely closed off.

FIG. 2 shows a continuous process for the production of, for example, a material composite according to FIG. 1. A semifinished product 16 with CNT filaments (not shown in more detail) is unrolled from a supply roller 17 and provided on both sides with a start layer of copper by two targets 19 in a PVD coating plant 18. The pretreated semifinished product 16 is then guided through an electrochemical bath 21 via deflection rollers, during which a deposition current is applied to the semifinished product via an electrode arrangement (not shown in more detail). Here, the semifinished product 16 is connected as cathode, and therefore further coating with copper can take place.

After the semifinished product 16 has been guided out of the bath 21, it is introduced into a heat treatment device 22. Here, there is a heater 23 which firstly dries the semifinished product 16 of the electrolyte and secondly allows, by way of example, the metallic matrix material to be heated to above the recrystallization temperature.

The semifinished product treated in this way, which already represents the material composite 11, can be processed further in different ways, FIGS. 3 and 4 showing two variants. According to FIG. 3, a severing device 24 is used to cut the material composite according to FIG. 2 into a plurality of strips, which, for example, can have the dimensions according to FIG. 1. In a subsequent step, the individual strands are twisted 25 (not shown in more detail), and these strands are then pulled out using a production device 26 to form a CNT wire 27. For this purpose, the production device 26 has a funnel-shaped hole 31 which, at one end, has the diameter of the CNT wire 27 to be produced. As it passes through the production device 26, the material composite 11 is stretched while its diameter is simultaneously reduced, and this firstly leads to cold work-hardening of the matrix material (copper) and secondly produces a preferred orientation of CNT filaments in the matrix material, which is oriented to the longitudinal orientation of the CNT wire 27 produced (similar to the case shown in FIG. 1).

Another possibility is not to cut the mat-like material composite 11 according to FIG. 4, but to process it by rolling in a rolling device 28. In this process, the thickness of the material composite is reduced and a certain orientation of the CNT filaments is also obtained in the rolling direction. In both cases (FIG. 3, FIG. 4), the product produced (CNT wire 27, CNT sheet 29) is rolled up onto a product roller for further processing.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A process producing a material composite, comprising:
providing a semifinished carbon nanotube (CNT) product embodied as a knitted fabric, a woven fabric, a mesh, a nonwoven or a paper; and
coating the semifinished CNT product with a material to form a metallic matrix such that carbon nanotube filaments are distributed in the metallic matrix.

14. The process as claimed in claim 13, wherein
the material of the metallic matrix is coated on the semifinished CNT product electrochemically, by electrodeposition.

15. The process as claimed in claim 14, wherein
electrochemical coating is preceded by pretreatment of the semifinished CNT product to improve electrical conductivity and/or adhesion properties for the material of the metallic matrix.

16. The process as claimed in claim 13, wherein
after coating the semifinished CNT product, the material composite is subjected to heat treatment.

17. The process as claimed in claim 13, wherein
after coating the semifinished CNT product, the material composite is stretched.

18. The process as claimed in claim 13, wherein
after coating the semifinished CNT product, the material composite is separated into a plurality of sub-sections.

19. The process as claimed in claim 13, wherein
after coating the semifinished CNT product, the material composite is folded and/or layered and/or twisted.

20. The process as claimed in claim 13, wherein
the semifinished CNT product has a strand-like form, and
the process is carried out continuously such that the semifinished CNT product and the resulting strand-like material composite are moved through the process.

21. The process as claimed in claim 15, wherein
after coating the semifinished CNT product, the material composite is subjected to heat treatment.

22. The process as claimed in claim 21, wherein
after coating the semifinished CNT product, the material composite is stretched.

23. The process as claimed in claim 22, wherein
after coating the semifinished CNT product, the material composite is separated into a plurality of sub-sections.

24. The process as claimed in claim 23, wherein
after coating the semifinished CNT product, the material composite is folded and/or layered and/or twisted.

25. The process as claimed in claim 24, wherein
the semifinished CNT product has a strand-like form, and
the process is carried out continuously such that the semifinished CNT product and the resulting strand-like material composite are moved through the process.

26. A material composite comprising:
an intertwined, interwoven or interlinked formation of carbon nanotube (CNT) filaments; and
a metallic matrix in which CNT filaments are distributed, wherein
the material composite has a form determined by hardening and then cold forming the metallic matrix.

27. The material composite as claimed in claim 26, wherein the CNT filaments have a preferred orientation in the material composite.

28. The material composite as claimed in claim 26, wherein the material composite has a strand-like form.

29. The material composite as claimed in claim 26, the CNT filaments, which are intertwined or interwoven or interlinked, are arranged in a plurality of adjacent layers in the metallic matrix.

30. The material composite as claimed in claim 27, wherein the material composite has a strand-like form.

31. The material composite as claimed in claim 30, the CNT filaments, which are intertwined or interwoven or interlinked, are arranged in a plurality of adjacent layers in the metallic matrix.
